(19) United States
(12) Patent Application Publication
(10) Pub. No.: US 2009/0194615 A1
(43) Pub. Date: Aug. 6, 2009

(54) Method for comminuting agglomerated pigments and pharmaceutical agents

(75) Inventor: Roland Schuessler, Schlierbach (DE)

Correspondence Address: VENABLE LLP, P.O. BOX 34385, WASHINGTON, DC, 20043-9998, US

(73) Assignee: Pulsar GmbH Micronizing Systems, Leun (DE)

(21) Appl. No.: 11/663,498

(22) PCT Filed: Sep. 17, 2005
(86) PCT No.: PCT/EP05/10035

§ 371 Date: Mar. 22, 2007

(30) Foreign Application Priority Data
Sep. 22, 2004 (DE) 10 2004 045 895.2

(51) Int. Cl. B02C 19/06; B02C 23/08; B02C 23/20

(52) U.S. Cl. 241/5; 241/24.1; 241/18

(57) ABSTRACT

The invention relates to a method for mechanical processing of pigments or pharmaceutically active substances in the form of particles of raw product. In a first method step, the particles are classified as to size, wherein particles that are classified as fine particles inside the classifier are discharged as acceptable materials and wherein large particles that remain as residual material in the classifier are supplied to a comminuting device, where the particles are comminuted during a second processing step.

The invention relates to a method for the mechanical processing of pigments and pharmaceutically active substances.

The techniques of wet-chemical synthesis are primarily used for producing the aforementioned products. The respective pigments of the pharmaceutically active substances are precipitated out in the pure form, wherein these precipitates are subsequently treated in filtering units and dried in thermal driers.

Agglomerates develop during the drying process, meaning the pigments and pharmaceutically active substances are not present in the required fine powdery form. Rather, the pigments and pharmaceutically active substances are present in the form of non-uniform agglomerates, which can range in size from μm to cm. A comminuting of these agglomerates is difficult because of the differences in their structures. However, a conveying, metering out or further processing of the pigments and pharmaceutically active substances is only conditionally possible in the agglomerated state.

It is therefore the object of the present invention to provide a method for producing high-quality pigments or pharmaceutically active substances in powdery form.

This object is solved with the features disclosed in claim 1. Advantageous embodiments and useful modifications of the invention are described in the dependent claims.

The method according to the invention is used for the mechanical processing of pigments or pharmaceutically active substances that are present in the form of particles. The particles in the form of a raw product are classified during a first processing step. Particles classified as fine in the classifier are then discharged as acceptable products. Large particles that remain as residual material in the classifier are supplied to a device in which the particles are comminuted during a second processing step.

The method according to the invention is used to produce powdery pigments and pharmaceutically active substances, which can easily be processed further because of their defined and narrow particle-size distribution. In particular, the method according to the invention is designed to achieve an effective breakup of most of the agglomerated pigments and pharmaceutically active substances.

It is critical for the method according to the invention that these particles are classified prior to the comminuting operation. During the classification, fine particles which already have the desired small particle sizes are classified as acceptable materials and are removed from the processing, meaning they are no longer supplied to the comminuting device. The device is therefore supplied only with large particles which accumulate in the classifier as residual matter. Since the fine particles are no longer fed to the device, any agglutination or clogging of the device caused by these particles is avoided. A further critical advantage is that owing to the initial classification, the device is supplied only with the material share containing large particles and not the total amount of the raw material. As a result, only a small portion of the raw products must be processed inside the device, thus making it possible to select a correspondingly low capacity for the device.

Claim 4 describes a particularly advantageous form of the method for comminuting the particles. In general, these particles are in the form of a plug and are shot with the aid of a pressure pulse against a baffle plate, wherein the plug is shot through a pipe and then flies freely outward from the pipe and toward the baffle plate. The pressure of the pulse, preferably a compressed air pulse, drops in the process and, in turn, causes a lowering of the temperature during the comminuting process at the baffle plate. Damaging thermal effects on the particles are thus avoided, especially the agglutination of the particles. A favorable thermal behavior of this type is a specific feature of the method as disclosed in claim 4. In contrast, a temperature increase generally occurs during comminuting processes in arrangements such as pinned disk mills and the like.

The invention is explained in the following with the aid of the drawings, which show in:

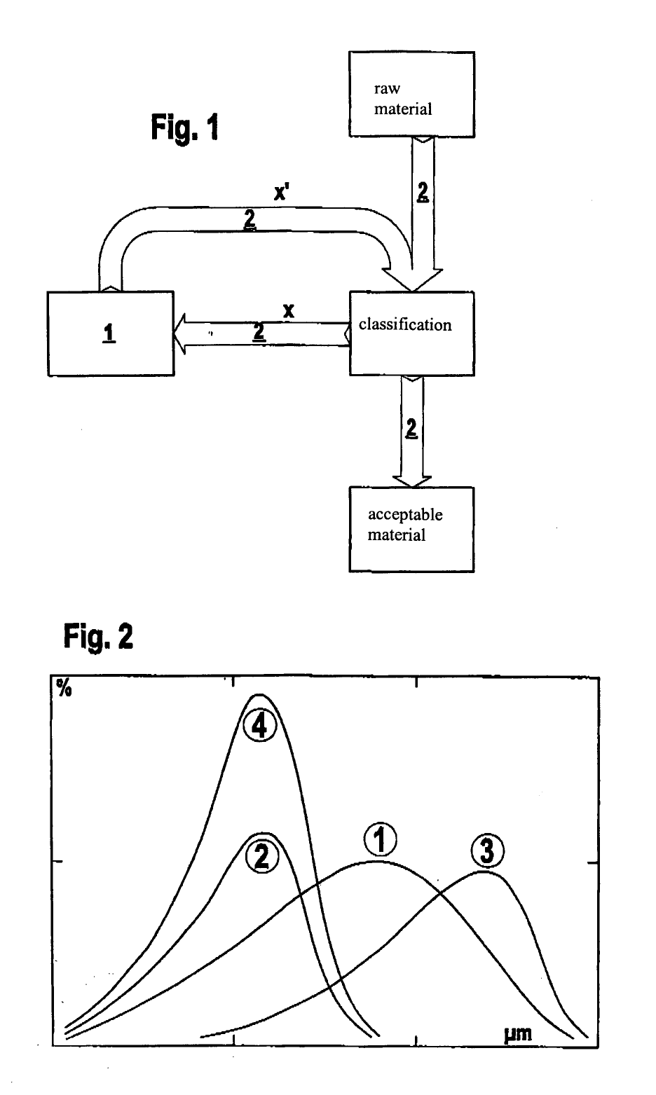

FIG. 1: A schematic representation of the various partial processing steps of the method according to the invention for the mechanical processing of pigments or pharmaceutically active substances, present in the form of particles.

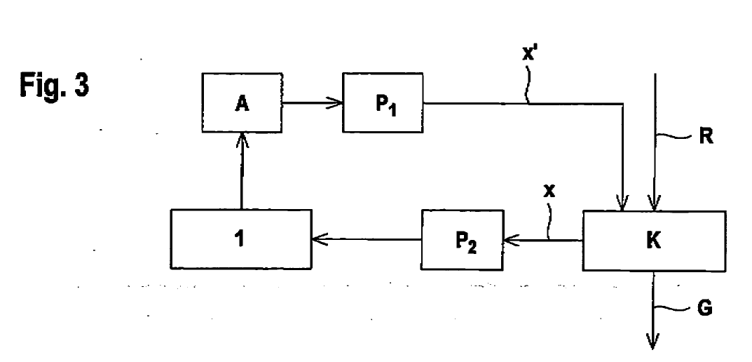

FIG. 2: The particle-size distribution during the various processing steps for the method according to FIG. 1.

FIG. 3: A schematic representation of an arrangement for realizing the method according to FIG. 1.

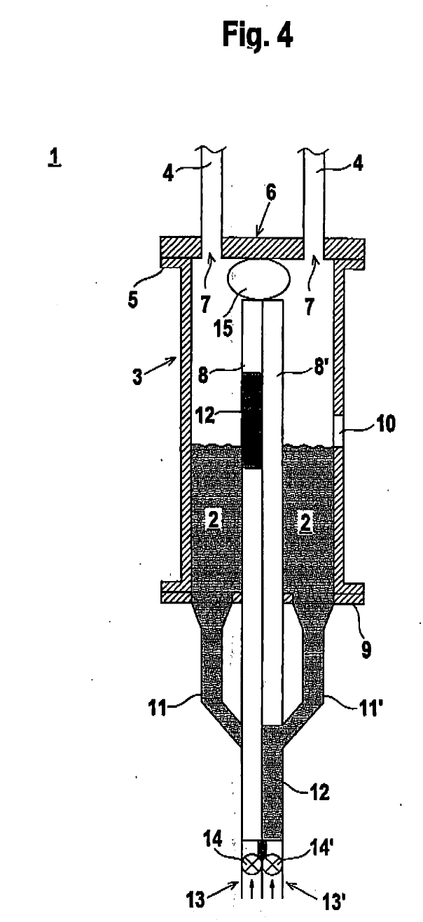

FIG. 4: A longitudinal section through a first exemplary embodiment of a device for comminuting particles, used with the arrangement shown in FIG. 3.

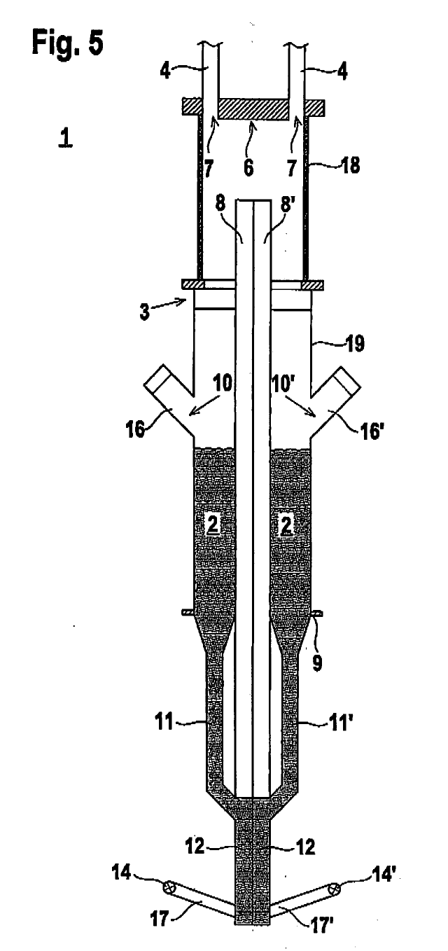

FIG. 5: A longitudinal section through a second exemplary embodiment of a device for comminuting particles, used with the arrangement shown in FIG. 3.

FIG. 1 schematically shows the sequence of method steps according to the invention for the mechanical processing of powdery pigments or pharmaceutically active substances. These substances are synthesized, for example, with wet-chemical processes and are then precipitated out in the pure form. Following the treatment in filtering units and in thermal driers, the pigments and pharmaceutically active substances are present in the form of a raw product.

The sequence of method steps for the mechanical processing of these raw products is shown in FIG. 1. FIG. 2 shows the particle-size distributions for these substances, obtained during the processing. FIG. 3 schematically shows a preferred embodiment of an arrangement for realizing the method according to the invention.

A classifier K and a device 1 are the essential components for realizing the method illustrated in FIG. 1 for comminuting the pigments or pharmaceutically active substances that are present in the form of particles 2. The particles 2 in the form of a raw material, which must be processed with this method, are partially agglomerated as a result of the previous treatment. The agglomerated particles have diameter sizes ranging μm to cm size, meaning the sizes can vary over several powers of ten. Accordingly, the raw products exhibit a correspondingly non-uniform, broad size particle spectrum, which is shown schematically in FIG. 2 with the distribution characterized by the reference 1.

In a first classification step, the raw products are classified inside a classifier K. The particles 2 that are classified as fine particles in the classifier K are then discharged from the processing operation as acceptable products. Corresponding to the design of the classifier K, for example embodied as screening machine, fine particles 2 up to a maximum diameter are discharged as acceptable products. The particle-size spectrum for the acceptable products, which are removed from the raw products, is shown schematically in FIG. 2 with the distribution given the reference 2.

During the classification, large particles 2 remain in the classifier K in the form of residual material. The residual particles 2 that remain in the classifier K are given the reference X in FIG. 1 and essentially comprise the agglomerated particles 2. These agglomerated particles are then comminuted in the device, shown with reference 1 in FIG. 1. The comminuted particles 2, which are discharged from the device 1 output and given the reference X′, are subsequently fed back to the classifier K, thereby resulting in a closed processing cycle. The amount X of particles 2 fed to the device 1 preferably corresponds to the amount X′ of comminuted particles 2 returned to the classifier K.

Reference 3 in FIG. 2 denotes the particle-size spectrum for the residual material in the classifier K, meaning the large particles. Reference 4 in FIG. 2 finally shows the particle-size spectrum for the total fraction of all acceptable products, obtained following a classification and comminuting.

The particle-size spectra in FIG. 2 shows that the method according to the invention permits a mechanical processing of the particles 2, in such a way that starting with the broad particle-size spectrum of agglomerate-containing particles 2, a narrow particle-size distribution of the acceptable product is obtained. In the process, agglomerates are for the most part removed from the acceptable products as a result of the comminuting process inside the device 1.

In principle, the particle flows with references X, X′, shown in FIG. 1, can also be supplied directly to the device 1 or the classifier K.

A particularly advantageous embodiment, shown in FIG. 3, provides for a temporary storage of the respective particle flows.

The arrangement shown in FIG. 3 is again provided with a classifier K, for example a screening machine, and a device 1 for comminuting the particles 2. A precipitator A and a first temporary storage P₁ are furthermore installed downstream of the device 1. A second temporary storage P₂ is installed downstream of the classifier K.

Analog to the diagram according to FIG. 1, the pigments or pharmaceutically active substances, which are present in the form of particles 2 and must be processed mechanically, are supplied as raw products (reference R in FIG. 3) to the classifier K. The fine particles 2, classified therein, are then discharged from the process as acceptable products (reference G in FIG. 3). The share X of the raw products, which accumulates in the classifier K as residual material, is subsequently supplied to the temporary storage P₂, which in the simplest case can be embodied as a container. From there, the particles 2 to be comminuted are supplied discontinuously to the device 1, preferably at predetermined time intervals.

The particles 2, which are comminuted in the device 1, are preferably discharged from the device by means of an air flow. Inside the precipitator A, the particles 2 are precipitated out of the air flow and are collected in the temporary storage P₁, which can again be embodied as a container. The amount X′ of comminuted particles 2 is then recycled from the container back to the classifier K, preferably discontinuously and at predetermined time intervals.

FIGS. 4 and 5 show devices 1 for comminuting particles 2, which can be used with the arrangements according to FIGS. 1 and 3 for the mechanical processing of pigments and pharmaceutically active substances.

The device 1 shown in FIG. 4 is provided with a hollow-cylindrical comminuting chamber 3, from which the comminuted particles 2 can be discharged via discharge pipes 4.

The comminuting chamber 3 is provided with a circular flange 5 at the open upper end, with thereon positioned baffle plate 6 that is preferably composed of steel and embodied as a circular disk. The baffle plate 6 contains a predetermined number of openings 7. For the exemplary embodiment shown herein, the openings 7 are round bore holes. A discharge pipe 4 adjoins each of the openings 7.

The baffle plate 6 can be installed easily on the device 1 by mounting it on the circular flange 5. In particular, the baffle plate 6 can be exchanged without requiring an involved assembly and can be replaced with different baffle plates 6 having differently arranged openings 7.

Two pipes 8, 8′ inside the comminuting chamber 3 extend parallel to the longitudinal axis of the comminuting chamber 3. In principle, it is also possible to provide only one pipe 8 or 8′, wherein a larger number of pipes 8, 8′ can also be provided.

The pipes 8, 8′ are positioned directly adjacent to each other in the center of the comminuting chamber 3 and discharge into the bottom 9 of this chamber. The exit openings on the upper ends of the pipes 8, 8′ are positioned at a predetermined distance to the baffle plate 6.

An opening 10 is provided in the side wall of the comminuting chamber 3. Via this opening 10, the inside space of the comminuting chamber 3 is filled up to a specified filling level with the particles 2 to be comminuted. With the arrangement according to FIG. 3, the particles are supplied from the temporary storage P₂.

Two feed pipes 11, 11′ empty into the bottom 9 of the comminuting chamber 3. The upper sections of these feed pipes 11, 11′ extend parallel to the sections of pipes 8, 8′ that project past the comminuting chamber 3. The lower ends of the feed pipes 11, 11′ are curved, thereby extending toward the pipes 8, 8′, wherein respectively one feed pipe 11, 11′ empties into one pipe 8, 8′. Owing to this embodiment of the pipes 8, 8′, a portion of the particles 2 is guided from the comminuting chamber 3 via the feed pipes 11, 11′ into the lower ends of the pipes 8, 8′ and forms a plug 12 with a specified filling level. In FIG. 4, the lower end of the pipe 8′ on the right contains such a plug 12.

Respectively one pressure pulse unit 13, 13′ with a valve 14, 14′ adjoins the lower end of each pipe 8, 8′. The plug 12 at the lower end can thus be subjected to a pressure pulse of a predetermined level and duration via the pressure pulse unit 13, 13′. Gas with a predetermined gas pressure is present at the valve 14, 14′ for generating the pressure pulse, wherein the gas is preferably air. Alternatively, an inert gas, a cryogenic gas, or hot gas can also be used. An abrupt opening of the valve 14, 14′ causes the gas to flow with explosive force into the pipe 8, 8′ above, thereby shooting the plug 12 through the pipe 8, 8′ and against the baffle plate 6. The pressure pulse level typically is in the range of 5 bar to 10 bar. With pressure pulses of this type, the plug 12 can reach movement speeds ranging from 70 m/s to 100 m/s.

In the exemplary embodiment shown in FIG. 4, the valve 14′ of the pressure pulse unit 13′ that is connected to the right pipe 8′ is closed, so that the plug 12 is in its resting position at the bottom 9 of pipe 8.

By opening the valve 14 of the respective pressure pulse unit 13, the plug 12 in the left pipe 8 is shot upward, wherein the snapshot in FIG. 4 shows the plug 12 positioned at the upper end of pipe 8, just prior to leaving the exit opening.

After exiting the respective pipe 8, 8′, the plug 12 impacts with the baffle plate 6, wherein the movement direction for the present embodiment is perpendicular to the surface of the baffle plate 6.

It is critical that the duration of the pressure pulse is selected to be shorter than the movement time for the plug 12 inside the respective pipe 8, 8′, so that the plug 12 is no longer admitted with the pressure pulse while traveling the distance between the exit opening of pipe 8, 8′ and the baffle plate 6. An undesirable fanning out of the particles 2 before the particles 2 impact with the baffle plate 6 is consequently avoided, so that the shape of the plug 12 is at least nearly preserved until the particles 2 impact with the baffle plate 6. Owing to the fact that the particles 2 impact in a compact form with the baffle plate 6, the reaction force exerted by the baffle plate 6 propagates through all particles 2 in the plug 12, thereby achieving an efficient and complete comminuting of the particles 2 as a result of the shearing forces acting upon the particles 2.

FIG. 4 shows that no openings 7 are provided in the area where the particles 2 impact with the baffle plate 6, so that no particles 2 are shot directly through the openings 7.

FIG. 4 schematically shows the comminuted particles 2, which are reflected at the baffle plate 6 and form a dust cloud 15. The pressure pulse causes excess pressure on the front of the baffle plate 6, so that the comminuted particles 2 are transported through the openings 7 and into the discharge pipes 4. In the arrangement according to FIG. 3, the comminuted particles 2 are supplied via an air flow and the discharge pipes 4 to the precipitator A, wherein only particles up to a predetermined size can pass through the openings 7 while larger particles 2 fall back into the comminuting chamber 3 because of their higher weight and are again fed to the pipes 8, 8′ for forming new plugs 12.

The particle sizes and the size distributions for the comminuted particles 2 can be predetermined by suitably dimensioning the diameters of the pipes 8, 8′ and through a suitable selection of the number and sizes of the openings 7 in the baffle plate 6.

A control unit that is not shown herein is used to control the pressure pulse units 13, 13′ and to generate with predetermined timing sequences of pressure pulses. The pressure pulse units 13, 13′ are preferably controlled such that a plug 12 is shot alternately from the left or the right pipe 8 or 8′ against the baffle plate 6. The cycles for filling the pipes 8, 8′ with the individual plugs 12 are in the range of seconds or even milliseconds, so that the clocking rate for the pressure pulses can be selected correspondingly high. In this way, the individual plugs 12 are shot quickly and one after another against the baffle plate 6, so that a quasi continuous comminuting process and a correspondingly high throughput can be achieved with the device 1.

Following the shooting of a plug 12 from one of the pipes 8, 8′, the respective pipe 8, 8′ is filled once more with particles 2 via the respective filling pipe 11, 11′, so as to form a new plug 12. It is advantageous in this case that the shock wave resulting from the shooting of a plug 12 shakes up the particles 2 in the comminuting chamber 3, so that these are consequently supplied at an increased speed to the feed pipe 11, 11′, thereby aiding the re-loading of the pipe 8, 8′ to form a plug 12. This loading function is further reinforced by the excess pressure in the upper part of the comminuting chamber 3, which exists when the plug 12 impacts with the baffle plate 6.

FIG. 5 shows a second exemplary embodiment of the device 1 according to the invention, wherein the design of the device 1 shown therein is nearly identical to the design for the device in the exemplary embodiment according to FIG. 4.

In contrast to the exemplary embodiment shown in FIG. 4, the device 1 according to FIG. 5 has a comminuting chamber 3 that is provided with two openings 10, 10′ for the pipe extensions 16, 16′ in the side wall, through which particles 2 are filled into the comminuting chamber 3.

A further difference is that feed extensions 17, 17′, which are positioned at an angle to the pipes 8, 8′, discharge into the lower ends of the pipes 8, 8′ in which the respective plugs 12 are located. The valves 14, 14′ for the pressure pulse units 13, 13′ that are not shown in further detail herein are located inside these feed extensions 17, 17′.

The longitudinal axes of the feed pipes 8, 8′ can extend in a horizontal plane that is oriented perpendicular to the longitudinal axis of the device 1 or, as shown in FIG. 5, can preferably extend at a maximum angle of 20° relative to this plane.

The final difference to the exemplary embodiment shown in FIG. 4 is that the comminuting chamber 3 has an upper part 18 with a slightly smaller cross section than the cross section of the lower part 19 of the comminuting chamber 3. In principle, the upper and the lower parts 18, 19 can also be embodied as two parts. At the adjoining open ends of the upper part 18 of the comminuting chamber 3, the baffle plate 6 is attached such that it can be detached once more and replaced if necessary.

### LIST OF REFERENCE NUMBERS

(1) device
(2) particles
(3) comminuting chamber
(4) discharge pipes
(5) circular flange
(6) baffle plate
(7) opening
(8) pipe
(8′) pipe
(9) bottom
(10) opening
(10′) opening
(11) feed pipe
(11′) feed pipe
(12) plug
(13) pressure pulse unit
(13′) pressure pulse unit
(14) valve
(14′) valve
(15) dust cloud
(16) filling extension
(16′) filling extension
(17) feed extension
(17′) feed extension
(18) upper part
(19) lower part
(A) precipitator
K classifier
P₁ temporary storage
P₂ temporary storage

1. A method for mechanical processing of pigments or pharmaceutically active substances, comprised of particles in the form of raw material, comprising:
classifying the particles in a classifier as to size;
discharging particles, classified as fine, as acceptable materials;
supplying large particles, remaining in the classifier as residual material, to a comminuting device; and
subsequently comminuting the large particles in the comminuting device.

2. The method according to claim 1, further including:
subsequent to comminuting returning the particles to the classifier.

3. The method according to claim 1, wherein the classifier includes a screening machine.

4. The method according to claim 1, wherein comminuting the particles includes:
collecting a predetermined amount of particles in at least one pipe,
forming a plug with the collected particles,
applying to he plug a pressure pulse of a predetermined duration and level,
shooting the plug via an exit opening in the pipe against a baffle plate including at least one opening,
comminuting the particles by the reaction force at the baffle plate, and
transporting the comminuted particles through the baffle plate opening.

5. The method according to claim 4, wherein the baffle plate includes a plurality of openings.

6. The method according to claim 4, further including:
transporting only the particles, which are finely comminuted by the reaction force at the baffle plate through the opening in the baffle plate; and
supplying larger particles to the pipe.

7. The method according to claim 1, further including:
subsequent to comminuting, moving the comminuted particles to a temporary storage.

8. The method according to claim 7, wherein moving further includes:
moving the comminuted particles with an air flow to a precipitator disposed downstream of the comminuting device;
precipitating the particles in the precipitator; and
supplying the precipitated particles to the temporary storage.

9. The method according to claim 8, further including:
supplying the comminuted particles at predetermined time intervals from the temporary storage to the classifier.

10. The method according to claim 1, further including:
prior to comminuting, storing the large particles, which accumulate as residual material in the classifier, in a storage device;
supplying the stored large particles to the device; and
comminuting the large particles in the device.
